(19) United States
(12) Patent Application Publication
(10) Pub. No.: US 2019/0243419 A1
(43) Pub. Date: Aug. 8, 2019

(54) Tablet Computing Device Case with Hand Retaining System and Method of Use

(71) Applicant: Mobile Tech, Inc., Lake Oswego, OR (US)

(72) Inventors: Eric Charlesworth, Lake Oswego, OR (US); Hoa Pham, Tigard, OR (US)

(21) Appl. No.: 16/268,017

(22) Filed: Feb. 5, 2019

Related U.S. Application Data
(60) Provisional application No. 62/627,015, filed on Feb. 6, 2018.

(51) Int. Cl. G06F 1/16; A45C 11/00; H04B 1/3827; H04B 1/3888

(52) U.S. Cl. CPC G06F 1/1632; G06F 1/1656; A45C 11/00; H04B 1/385; H04B 2001/3861; G06F 1/1626; A45C 2200/15; A45C 2011/003; H04B 1/3888

(57) ABSTRACT

A tablet case includes a frame, a connector, a swivel, and a hand strap. The frame is configured to retain a tablet computing device and has a front and a rear. The connector is coupled to the frame and protrudes from the rear of the frame. The connector is configured to releasably attach the frame to a docking station. The swivel is rotatable about the connector, and the hand strap is attached to the swivel. The hand strap is moveable between a handheld position and a dock ready position. The hand strap is resiliently biased to the dock ready position. The handheld position is a position in which the hand strap is spaced from the frame such that a user's hand can be inserted, and the dock ready position is a position in which the hand strap does not interfere with docking of the tablet case to a docking station.

### CROSS-REFERENCE AND PRIORITY CLAIM TO RELATED PATENT APPLICATION

This patent application claims priority to U.S. provisional patent application Ser. No. 62/627,015, filed Feb. 6, 2018, and entitled “Tablet Computing Device Case with Hand Retaining System and Method of Use”, the entire disclosure of which is incorporated herein by reference.

### SUMMARY

This section provides a general summary of the disclosure, and is not a comprehensive disclosure of its full scope or all of its features.

An aspect of the disclosure provides a tablet case for retaining a tablet computing device and releasably docking the tablet computing device to a docking station. The tablet case includes a frame, a connector, a swivel, and a hand strap. The frame is configured to retain a tablet computing device and has a front and a rear. The frame is configured to provide access to a display of the tablet computing device. The connector is coupled to the frame and protrudes from the rear of the frame. The connector is configured to releasably attach the frame to a docking station. The swivel is positioned about the connector and is connected to the frame. The swivel is rotatable about the connector. The hand strap is attached to the swivel, and the hand strap is moveable between a handheld position and a dock ready position. The hand strap is resiliently biased to the dock ready position. The handheld position is a position in which the hand strap is spaced from the rear of the frame sufficiently to enable a user's hand to be between the hand strap and the rear of the frame, and the dock ready position is a position in which the hand strap does not interfere with docking of the tablet case to the docking station.

Another aspect of the disclosure provides a hand retaining system for use with a tablet case for retaining a tablet computing device and releasably docking the tablet computing device to a docking station. The hand retaining system includes a connector, a swivel, and a hand strap. The connector is configured to attach to a tablet case. The swivel is positioned about the connector such that the swivel is rotatable about the connector. The hand strap is attached to the swivel and is made of a material having a Shore durometer measurement of at least 75 (A) and no greater than 95 (A). The hand strap is configured such that the hand strap is moveable between a handheld position and a dock ready position. The hand strap is resiliently biased to the dock ready position. The handheld position is a position in which the hand strap is spaced from the rear of the frame sufficiently to enable a user's hand to be between the hand strap and the rear of the frame, and the dock ready position is a position in which the hand strap does not interfere with docking of the tablet case to the docking station.

Another aspect of the disclosure provides a method for using a tablet case for retaining a tablet computing device. The method includes removing the tablet case from a docking station by pulling a frame of the tablet case away from the docking station such that a connector coupled to the frame and protruding from a rear face of the frame disengages from the docking station. The method further includes flexing a hand strap away from the rear face of the frame. The hand strap is coupled to a swivel positioned about the connector and rotatable about the connector. The hand strap is resiliently biased toward the rear face of the frame. The method still further includes inserting a hand into the hand strap.

These and other aspects will become apparent to those skilled in the art in light of the following disclosure and accompanying drawings. The description and specific examples in this summary are intended for purposes of illustration only and are not intended to limit the scope of the present disclosure.

### BRIEF DESCRIPTION OF THE DRAWINGS

The accompanying drawings, which are incorporated in and form a part of the specification, illustrate the embodiments of the present disclosure and together with the description, serve to explain the principles of the disclosure.

FIG. 1 is a side perspective view of a tablet case for retaining a tablet computing device and for releasably docking the tablet computing device to a docking station.

FIG. 2 is a rear perspective view of the tablet case shown in FIG. 1.

FIG. 3 is a front perspective view of a docking station for use with the tablet case shown in FIG. 1.

FIG. 4 is a partially exploded view of the tablet case shown in FIG. 1.

FIG. 5 is a front perspective view of a swivel of the tablet case shown in FIG. 1.

FIG. 6 is a perspective view of a hand strap of the tablet case shown in FIG. 1.

FIG. 7 is a rear perspective view of the tablet case shown in FIG. 1 with an alternative embodiments of a swivel and a hand strap.

FIG. 8 is a perspective view of the swivel and the hand strap shown in FIG. 7.

FIG. 9 is an exploded view of the of the connector of the tablet case shown in FIG. 7.

FIG. 10 is a rear left perspective view of the tablet case shown in FIG. 7 with the hand strap in a kickstand position.

FIG. 11 is a rear right perspective view of the tablet case shown in FIG. 7 with the hand strap in a kickstand position.

Reference characters in the written specification indicate corresponding items shown throughout the drawing figures.

### DETAILED DESCRIPTION OF EXAMPLE EMBODIMENTS

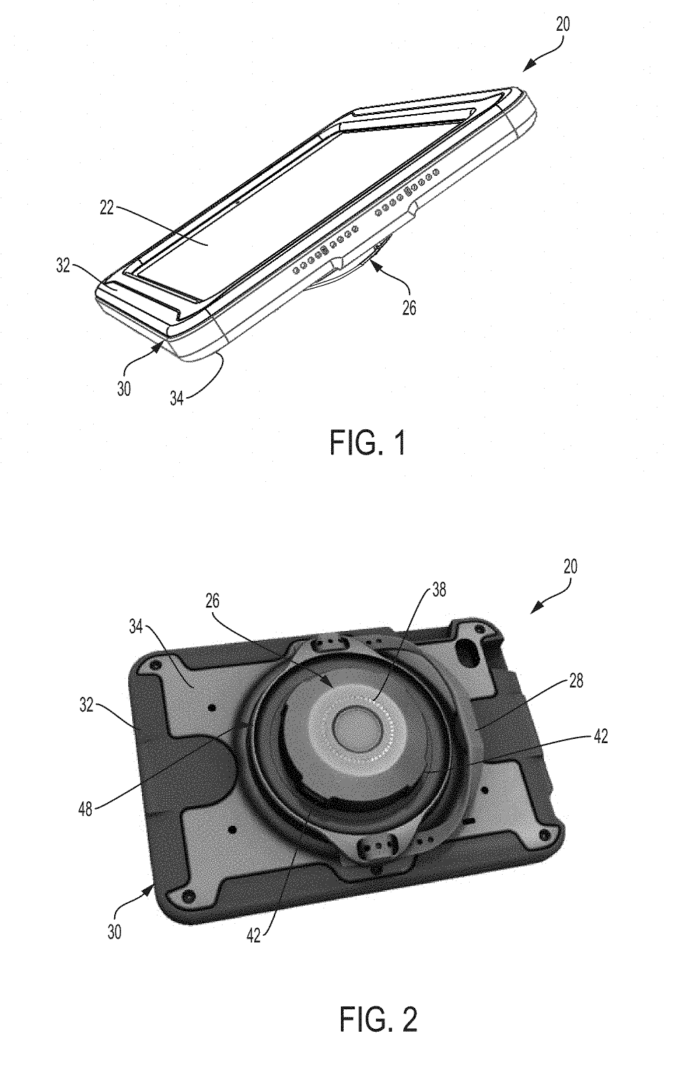

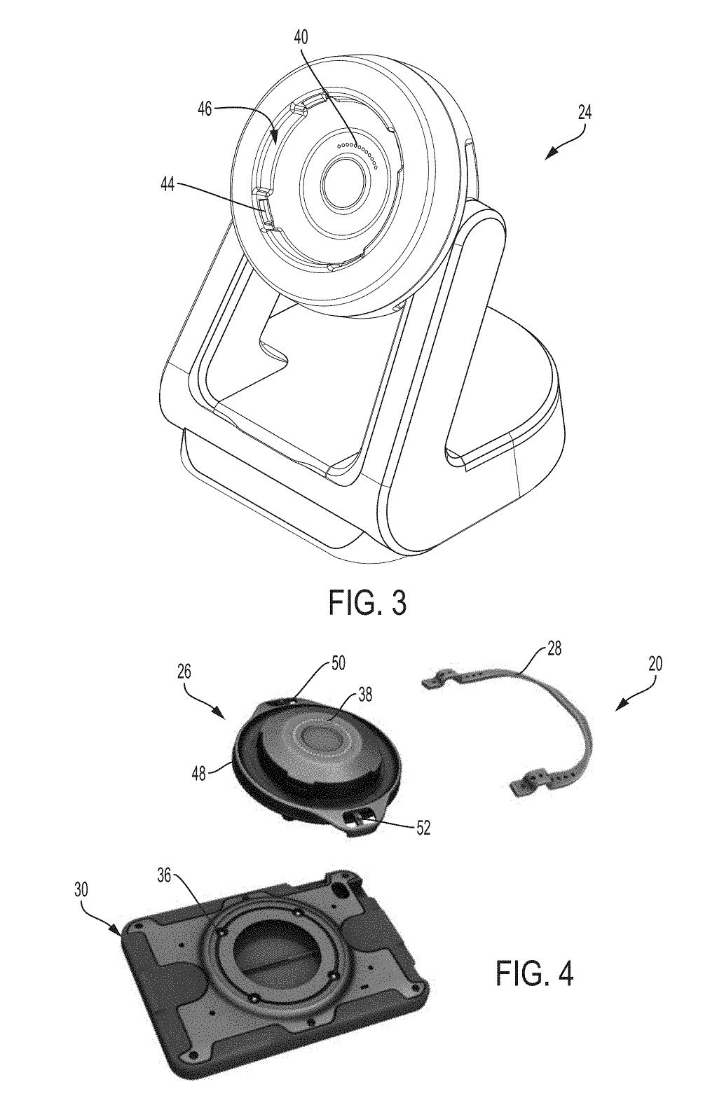

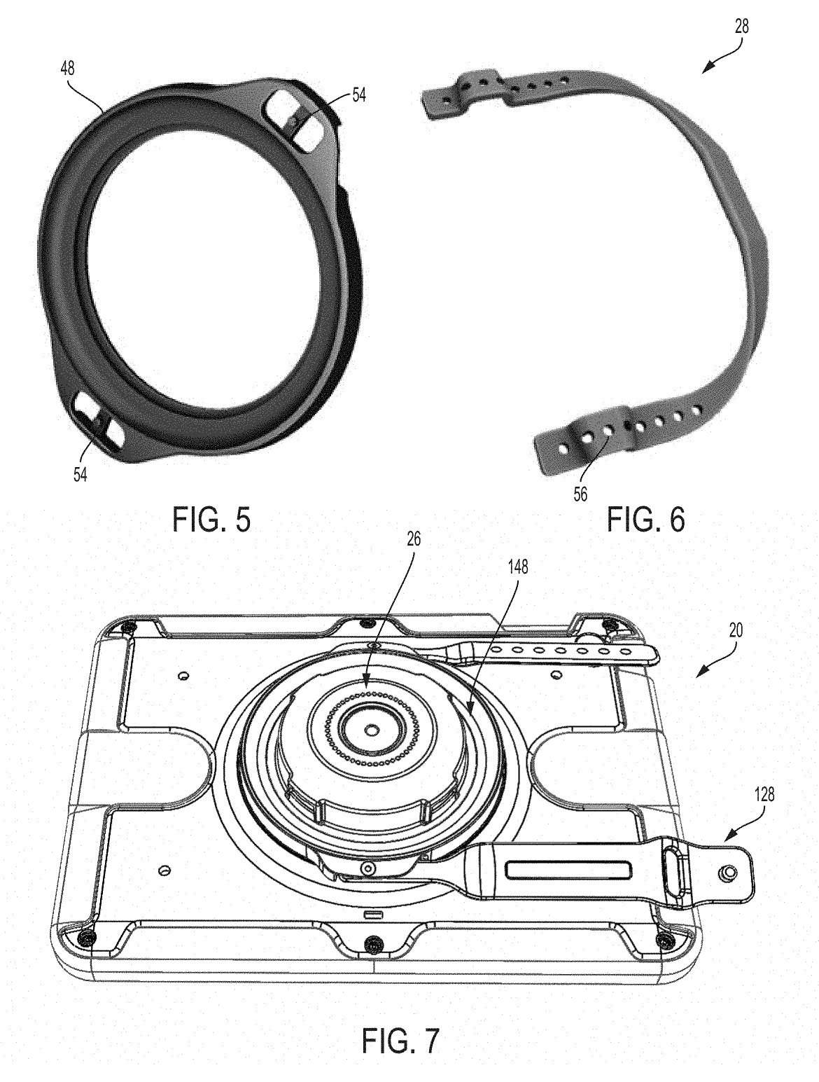

Referring to FIGS. 1-6, a tablet case 20 is shown according to one embodiment. The tablet case 20 is configured to retain a tablet computing device 22 and to releasably dock the tablet computing device 22 to a docking station 24. This allows the tablet 22 to be used in a handheld mode and a docked mode depending on the needs of the user. The tablet case 22 may be further docked to the docking station 24 to provide a power and/or data connection to one or more other devices such that the tablet computing device 22 may be charged and/or data may be read from or written to the tablet computing device 24.

The tablet case 20 includes a connector 26 configured to interface with the docking station 24 such that the tablet case 20 can be releasably docked to the docking station 24. The tablet case 20 further includes a hand strap 28 that facilitates use of the tablet computing device 22 in the handheld mode. As explained later herein in greater detail, the hand strap 28 is useable in a handheld position such that a user can insert a hand into the strap to hold the tablet case 20 securely with a single hand. The hand strap 28 is further biased toward a dock ready position such that the hand strap 28 does not interfere with docking of the tablet case 20 to the docking station 24. Furthermore, the hand strap 28 is useable in a kickstand in some embodiments to position the tablet case 20 on a surface and angled relative to the surface.

The tablet computing device 22 is secured within the tablet case 20 by a frame 30. The frame 30 is configured to retain the tablet computing device 22 and provide access to a display of the tablet computing device 22. The frame 30 has a front 32 and a rear 34. For example, the front 32 may be releasably coupled to the rear 34 such that the front 32 may be removed from the rear 34 to insert or remove a tablet computing device 22 from the tablet case 20. The front 32 and the rear 34 are secured to one another by fasteners. The frame 30 may differ from the depicted embodiment and be of any configuration for releasably retaining the tablet computing device 22.

Examples of a docking system that may include a tablet case 20 and docking station 24 for use with a tablet computing device 22 and a handstrap 28 as discussed herein are described in U.S. Pat. No. 10,101,770, the entire disclosure of which is incorporated herein by reference.

The connector 26, for docking the tablet case 20 to the docking station 24, is coupled to the frame 30 and protrudes from the rear 34 of the frame 30. The connector 26 is releasably connected to the frame 30 by fasteners 36. This connection allows for the removal of the connector 26 for servicing, replacement, or the like.

The connector includes two or more contact pads 38 configured to connect to corresponding contacts 40 on the docking station 24 such that an electrical connection is made between the connector 26 and the docking station 24. The tablet computing device 20 may be coupled to the contact pads 38 of the connector 26 such that, when docked, the tablet computing device may be charged and/or may transfer or receive data via the electrical connection with the docking station. It should be understood that as used herein the terms “contact pads” and “contacts” encompass any electrical connector capable of forming a connection of the type described herein (e.g., any combination of pads, pins, male and female connectors, plug and socket connectors, or the like).

The connector 26 has a cylindrical body including a plurality of cutouts 42 positioned radially about the body of the connector 26. Each cutout 42 is configured such that a corresponding retractable flange 44 of the docking station 24 can engage and disengage with the cutout 42 to releasably secure the tablet case 20 to the docking station 24. The flanges 44 of the docking station 24 are actuated by a solenoid such that they extend and retract to dock and undock the tablet case 20. For example, and without limitation, the solenoids may be operated by the use of a key (e.g., an electronic keycard) to control the undocking of the tablet case 20 from the docking station 24. The docking station 24 further defines a void 46 that is sized to receive the cylindrical body of the connector 26. In alternative embodiments, the connector 26 and/or the docking station 24 has other shapes and/or other features for connecting the connector 26 to the docking station 24. Furthermore, the docking station 24 may have other features or components for releasably securing the tablet case 20.

The connector 26 further includes or defines a bearing race that receives a swivel 48 such that the swivel is rotatable about the connector 26 and relative to the frame 30. The connector 26 connects the swivel to the frame 30. In alternative embodiments, the swivel 48 is otherwise connected to the frame 30 (e.g., connected directly by a bearing assembly). The hand strap 28 is attached to the swivel 48. This allows a user to rotate the tablet case 20 between at least a portrait orientation and a landscape orientation with the user's hand being in the hand strap 28. Advantageously, this allows the user to angle the tablet computing device 22 depending on the use of the tablet computing device 22 (e.g., angled for use by the user, angled for use by a customer of the user, or the like). The tablet case 20 is also rotatable without a user's hand in the hand strap 28. For example, the hand strap 28 may be positioned to serve as a kickstand for the tablet case 20 in either a portrait or landscape orientation.

The hand strap 28 is attached to the swivel 48 at a first connection point 50 and a second connection point 52 of the swivel 48. The second connection point 52 opposes the first connection point 50. In some embodiments, and as depicted in FIGS. 1-6, the first 50 and second 52 connections points each include a post 54. The hand strap 28 is a one-piece member and has a plurality of spaced apart notches 56. Each notch 56 is configured to engage with a post 54 such that the hand strap 28 is size adjustable. The hand strap 28 may be fed through the connection point 50, 52 and attached to the post 54 as shown in FIG. 2.

The hand strap 28 is moveable between a handheld position and a dock ready position (e.g., as shown in FIGS. 2 and 7) to facilitate handheld use and docking of the tablet case 20. The hand strap is spaced from the rear 34 of the frame 30 when in the handheld position to enable a user's hand to be positioned between the hand strap 28 and the rear 34 of the frame 30. The hand strap 28 is resiliently biased to the dock ready position such that in an absence of a force the hand strap 28 does not interfere with docking of the tablet case 20 to the docking station 24. In other words, the hand strap 28 is normally in the dock ready position such that it does not interfere with docking but can be flexed away from the frame 30 such that a user may insert a hand into the hand strap 28. In this handheld mode, the hand strap 28 may be positioned over the connector 26 such that docking of the tablet case 20 would be interfered with (e.g. the hand strap 28 would be positioned between the connector 26 and the docking station 24 impeding docking of the connector 26 into the docking station 24). When a user removes their hand from the hand strap 28, the hand strap automatically moves into the dock ready position out of the way of the connector 26 as a result of the biasing of the hand strap 28.

For example, and without limitation, the connector 26 protruding from the rear 34 of the frame 30 terminates in a plane spaced from the rear 34 of the frame 30, and the hand strap 28 is positioned between the plane and the rear 34 of the frame 30 when in the dock ready position. As a result, the hand strap 28 is prevented from coming between the connector 26 and the docking station 24 absent a force such as a user's hand preventing the hand strap 28 from moving into the dock ready position.

In some embodiments, the hand strap 28 is biased as a result of the material from which the hand strap 28 is constructed and/or the manner in which the hand strap 28 is coupled to the swivel 48. For example, the hand strap may be constructed of a material having a Shore durometer measurement of at least 75 (A) and no greater than 95 (A) (e.g., a plastic). The hand strap is flexible such that it returns to the dock ready position when a user's hand is not within the hand strap 28. In other words, the hand strap 28 is un-flexed when in the dock ready position and flexed when in the hand held position. In alternative embodiments, the hand strap 28 remains flexed and biased towards the dock ready position when in the dock ready position. For example, the hand strap may be made of a flexible material and positioned such that the hand strap 28 is positioned against and biased toward the frame 30 when in the dock ready position.

In alternative embodiments, the hand strap 28 is otherwise biased toward the dock ready position. For example, and without limitation, the hand strap 28 may be coupled to one or more biasing members (e.g., springs) that bias the hand strap 28 to the dock ready position.

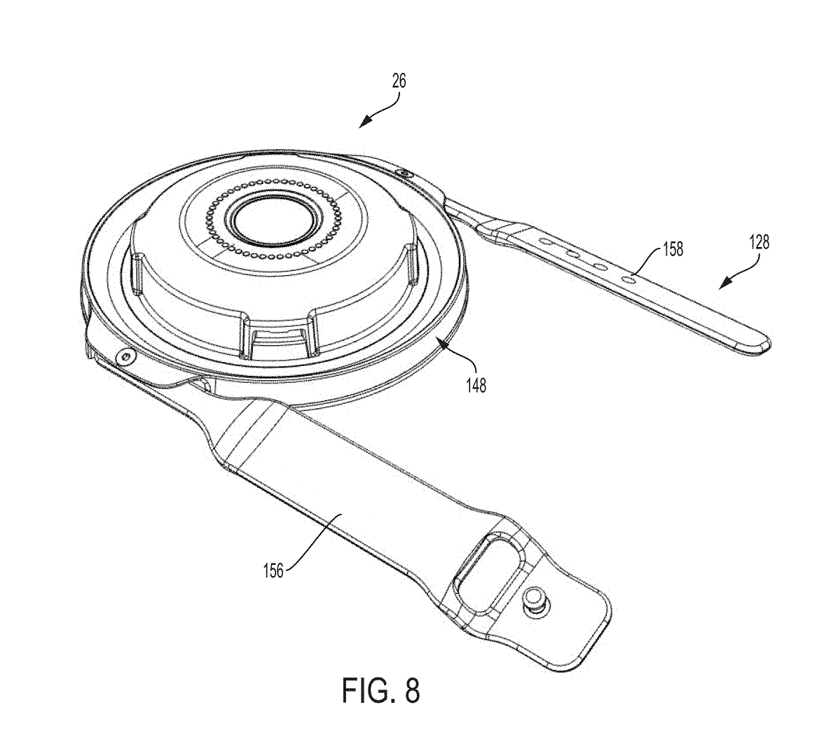

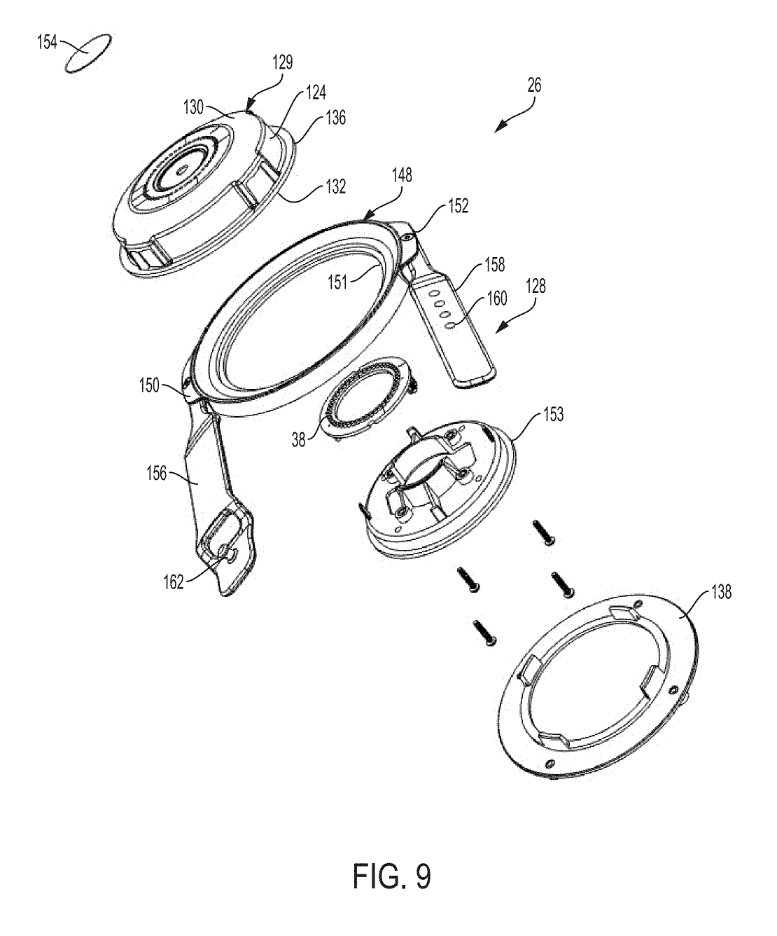

FIGS. 7-9 depict a tablet case 120 with an alternative swivel 148 and an alternative hand strap 128, both similar to their counterparts previously described (swivel 48 and hand strap 28). The remaining components of the tablet case 120 are identical to those previously described with reference to the tablet case 20 (e.g., the connector 26 of the tablet case 120 is the same as the connector 26 of the tablet case 20). As with tablet case 20 and the swivel 48, the swivel 148 is positioned within a bearing race of the connector 26. The connector includes a cylindrical body 129 having a top 130, a bottom 132, and a curved side 134. The cylindrical body 128 has a flange 136 extending radially from the side 134 nearer the bottom 132 than the top 130. The connector 26 also includes a circular backing plate 138 coupleable to the cylindrical body 128. The circular backing plate 138 is capable of being coupled to the rear 34 of the frame 30. The flange 136 and the backing plate 138 cooperate to form the bearing race within which the swivel 48, 148 rotate. The swivel 148 includes a portion 151 sized to fit within the bearing race and to secure the swivel 148 to the connector 26.

The connector 26 may further include an internal support 153 that positions the contact pads 38 within the connector 26. The connector 26 may further include other components and/or features for releasably connecting to the docking station 24. For example, the connector 26 may include a magnet 154 that interacts with a corresponding magnet on the docking station 24.

The hand strap 128 includes a male portion 156 and a separate female portion 158. The male 156 and female 158 portions cooperate to allow the hand strap 128 to be size adjustable. The female portion 158 includes a plurality of spaced apart notches 160, and the male portion 156 includes a post 162 sized to cooperate with a notch 160 to secure the male portion 156 to the female portion 158 when the post 162 is positioned within a notch 160. As the male 156 and female 158 portions allow for the size of the hand strap 128 to be changed, the male portion 156 an female portion 158 are permanently attached to a first connection point 150 and a second connection point 152, respectively, of the swivel 148. For example, the male 156 and female 158 portions may be secured to the swivel 148 by rivets, screws, or other suitable fasteners.

The hand strap 128 is otherwise the same as hand strap 28 previously described. The hand strap 128 is made of the a material having a Shore durometer measurement of at least 75 (A) and no greater than 95 (A). The hand strap 128 is also similarly flexible and moveable between a dock ready position and a handheld position while being biased to the dock ready position. The hand strap 128 is biased to the dock ready position regardless of whether the male 156 and female 158 portions are attached to one another or not.

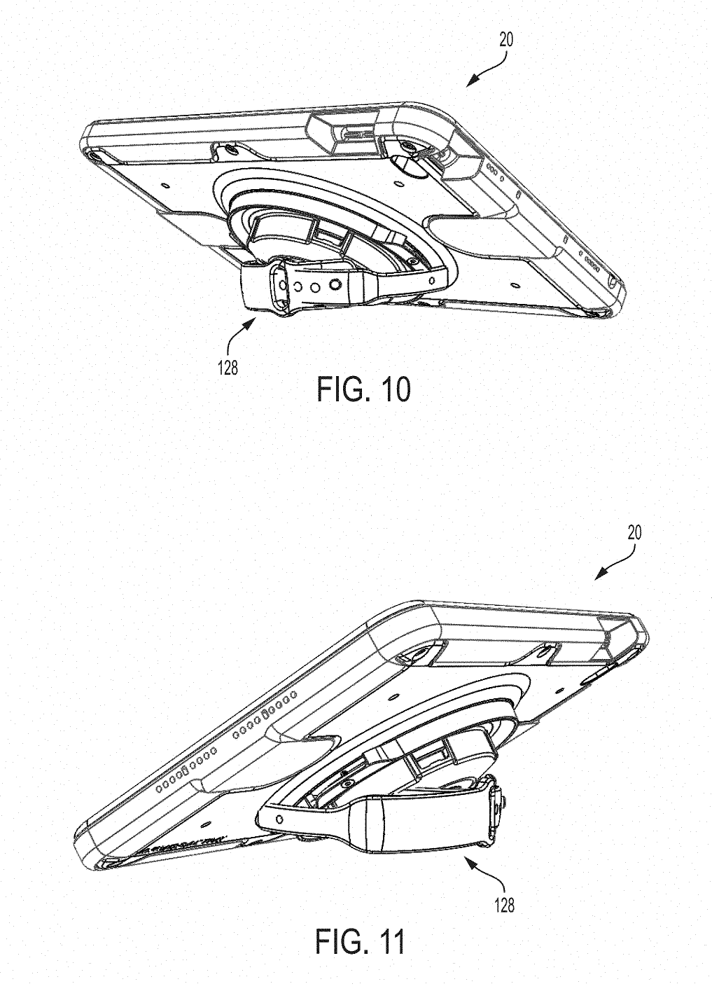

Referring now to FIGS. 10-11, the tablet case 20 is shown with the hand strap 128 in a kickstand position. It should be understood that these illustrations are exemplary and not limiting. For example, the hand strap 28 is similarly positionable in a kickstand position, and the tablet case 20 may also be oriented in a portrait orientation while the hand strap 128, 28 is in the kickstand position. The construction of the hand strap 28, 128 and its attachment to the swivel 48, 148 allow the hand strap 28, 128 to be used as a kick stand and support both the tablet case 20 and a tablet computing device 22 at an angle relative to a surface on which the tablet case 20 is placed. For example, the biasing of the hand strap 28, 128 and the material of construction provide for adequate support such that the hand strap 28, 128 is useable as a kickstand. A user may flex the hand strap 28, 128 away from the dock ready position and into a kickstand position (e.g., as illustrated) and place the tablet case 20 on the surface such that it is supported at an angle relative to the surface.

The features in each embodiment described above allow for the following operation of the tablet case 20. Referring generally to the Figures, a user may remove the tablet case 20 from the docking station 24 by pulling the frame 30 of the tablet case away from the docking station 24 such that the connector 26 disengages from the docking station 24. Removing the tablet case 20 from the docking station 24 may also include unlocking the docking station using a key as previously described herein. Once removed from the docking station 24, the user may flex the hand strap 28, 128 away from the rear face 34 of the frame 30 and out of the dock ready position. The user may flex the and strap 28, 128 into the handheld position and insert a hand into the hand strap 28, 128. Advantageously, this allows the user to securely hold the tablet case 20 with a single hand such that they may use their other hand to interact with the tablet computing device 22, a customer, merchandise, or the like. To return the tablet case 20 to the docking station 24, the user removes their hand from the hand strap 28, 128. The hand strap 28, 128 automatically moves into the dock ready position as a result of the biasing. The user may then dock the tablet case 20 by inserting the connector 26 into the docking station 24. Advantageously, the hand strap 28, 128 does not interfere with docking as it automatically moves into the dock ready position. This allows a user to easily dock the tablet case (e.g., using a single hand).

While in the handheld mode, a user may also remove their hand from the hand strap 28, 128 and flex the hand strap 28, 128 into the kickstand position. Before placing the tablet case 20 onto a surface, the user may rotate the swivel 48, 148 such that the tablet case 20 is positioned in a desired orientation (e.g., portrait or landscape orientation). The user may then set the tablet case 20 on a surface with the hand strap 28, 128 supporting the tab let case 20 and tablet computing device 22 at an angle relative to the surface and in the desired orientation.

The embodiments were chosen and described in order to best explain the principles of the disclosure and its practical application to thereby enable others skilled in the art to best utilize the disclosure in various embodiments and with various modifications as are suited to the particular use contemplated.

As various modifications could be made in the constructions and methods herein described and illustrated without departing from the scope of the disclosure, it is intended that all matter contained in the foregoing description or shown in the accompanying drawings shall be interpreted as illustrative rather than limiting. Thus, the breadth and scope of the present disclosure should not be limited by any of the above-described exemplary embodiments, but should be defined only in accordance with the following claims appended hereto and their equivalents.

What is claimed is:

1. A tablet case for retaining a tablet computing device and releasably docking the tablet computing device to a docking station, the tablet case comprising:
a frame configured to retain a tablet computing device, the frame having a front and a rear, the frame being configured to provide access to a display of the tablet computing device;
a connector coupled to the frame and protruding from the rear of the frame, the connector being configured to releasably attach the frame to a docking station;
a swivel positioned about the connector and being connected to the frame, the swivel being rotatable about the connector; and
a hand strap attached to the swivel, the hand strap being moveable between a handheld position and a dock ready position, the hand strap being resiliently biased to the dock ready position, the handheld position being a position in which the hand strap is spaced from the rear of the frame sufficiently to enable a user's hand to be between the hand strap and the rear of the frame, the dock ready position being a position in which the hand strap does not interfere with docking of the tablet case to the docking station.

2. A tablet case as set forth in claim 1, wherein the connector protruding from the rear of the frame terminates in a plane spaced from the rear of the frame, and wherein the hand strap is positioned between the plane and the rear of the frame when in the dock ready position.

3. A tablet case as set forth in claim 1, wherein the hand strap is in an un-flexed condition when in the dock ready position and in a flexed condition when in the handheld position.

4. A tablet case as set forth in claim 1, wherein the hand strap is further positionable in a kickstand position, the kickstand position being a position in which a portion of the hand strap and a portion of the frame are engaged with a surface and the frame is at an angle relative to the surface, the hand strap being configured to support the frame and the tablet computing device when in the kickstand position.

5. A tablet case as set forth in claim 1, wherein the connector comprises a cylindrical body having a top, a bottom, and a curved side, the cylindrical body having a flange extending radially from the side nearer the bottom than the top, and a circular backing plate coupled to the cylindrical body, the circular backing plate capable of being coupled to the rear of the frame, and wherein the flange and the backing plate cooperate to form a bearing race.

6. A tablet case as set forth in claim 5, wherein the swivel is a ring positioned within the bearing race of the connector, the swivel being rotatable within the bearing race.

7. A tablet case as set forth in claim 1, wherein the swivel includes a first connection point and a second connection point, the second connection point opposing the first connection point, the hand strap being attached to the swivel at the first connection point and the second connection point.

8. A tablet case as set forth in claim 7, wherein the first and second connections points each include a post, and wherein the hand strap is a one-piece member, the hand strap having a plurality of spaced apart notches, each notch being configured to engage with the post such that the hand strap is size adjustable.

9. A tablet case as set forth in claim 7, wherein the hand strap comprises a first portion and a second portion, the first portion being attached to the first connection point by a first fastener and the second portion being attached to the second connection point by a second fastener, the first portion being connectable to the second portion, the first portion being connected to the second portion when in the handheld position.

10. A tablet case as set for in claim 1, the hand strap being of a material having a Shore durometer measurement of at least 75 (A) and no greater than 95 (A).

11. A tablet case as set forth in claim 1, the connector comprising two or more contact pads configured to connect to corresponding contacts on a docking station such that an electrical connection is made between the connector and the docking station.

12. A hand retaining system for use with a tablet case for retaining a tablet computing device and releasably docking the tablet computing device to a docking station, the hand retaining system comprising:
a connector configured to attach to a tablet case;
a swivel positioned about the connector such that the swivel is rotatable about the connector; and
a hand strap attached to the swivel, the hand strap being of a material having a Shore durometer measurement of at least 75 (A) and no greater than 95 (A), the hand strap being moveable between a handheld position and a dock ready position, the hand strap being resiliently biased to the dock ready position, the handheld position being a position in which the hand strap is spaced from the rear of the frame sufficiently to enable a user's hand to be between the hand strap and the rear of the frame, the dock ready position being a position in which the hand strap does not interfere with docking of the tablet case to the docking station.

13. A hand retaining system as set forth in claim 12 wherein the swivel is a ring positionable within a bearing of the connector, the swivel being free to rotate within the bearing race.

14. A hand retaining system as set forth in claim 12, wherein the swivel includes a first connection point extending radially from the swivel and a second connection point extending radially from the swivel and opposing the first connection point, the hand strap attached to the swivel at the first connection point and the second connection point.

15. A hand retaining system as set forth in claim 14, wherein the first and second connections points each include a post, and wherein the hand strap is a one-piece member, the hand strap having a plurality of spaced apart notches, each notch being configured to engage with the post such that the hand strap is size adjustable.

16. A hand retaining system as set forth in claim 14, wherein the hand strap comprises a first portion and a second portion, the first portion being attached to the first connection point by a first fastener and the second portion being attached to the second connection point by a second fastener, the first portion being connectable to the second portion, the first portion being connected to the second portion when in the handheld position.

17. A method for using a tablet case for retaining a tablet computing device, the method comprising:
removing the tablet case from a docking station by pulling a frame of the tablet case away from the docking station such that a connector coupled to the frame and protruding from a rear face of the frame disengages from the docking station;
flexing a hand strap away from the rear face of the frame, the hand strap being coupled to a swivel, the swivel positioned about the connector and rotatable about the connector, the hand strap being resiliently biased toward the rear face of the frame; and
inserting a hand into the hand strap.

18. A method as set forth in claim 17 further comprising:
removing from the hand from the hand strap such that the hand strap moves toward the rear of the frame; and
docking the tablet case to the docking station by engaging the connector with the docking station.

19. A method as set forth in claim 17 further comprising:
removing the hand from the hand strap;
flexing the hand strap away from the rear face of the frame; and
placing the frame and the hand strap onto a surface such that the hand strap forms a kickstand supporting the tablet case at an angle relative to the surface.

20. A method as set forth in claim 17 further comprising rotating the swivel such that the frame is positioned in one of a portrait orientation or a landscape orientation.
